(19) United States
(12) Patent Application Publication
(10) Pub. No.: US 2011/0187858 A1
(43) Pub. Date: Aug. 4, 2011

(54) ELECTRONIC DEVICE AND METHOD FOR SURVEILLANCE CONTROL THEREOF

(75) Inventors: CHI-CHIH WANG, Tu-Cheng (TW); QUAN-ZHONG ZHANG, Shenzhen City (CN); XIAO CAI, Shenzhen City (CN); SHAO-FEI HAN, Shenzhen City (CN)

(73) Assignees: GDS SOFTWARE (SHENZHEN) CO.,LTD, ShenZhen City (CN); HON HAI PRECISION INDUSTRY CO., LTD., Tu-Cheng (TW)

(21) Appl. No.: 12/849,760

(22) Filed: Aug. 3, 2010

(30) Foreign Application Priority Data
Feb. 2, 2010 (CN) 201010301096.7

(51) Int. Cl. H04N 7/18; H04N 7/12; H04L 9/00

(52) U.S. Cl. 348/143; 375/240.01; 713/189; 348/E07.085; 375/E07.076

(57) ABSTRACT

An electronic device receives a playback request from a client terminal, using real time streaming protocol. The electronic device retrieves video data of a corresponding surveillance device via networks. The electronic device decodes and re-encodes the video data. The electronic device transmits the re-encoded video data to the client terminal.

### BACKGROUND

1. Technical Field

Embodiments of the present disclosure relate to user interfaces, and more particularly to an electronic device and method for surveillance control thereof.

2. Description of Related Art

Vendors of surveillance devices rarely adopt unified surveillance system software. Incompatibilities among surveillance systems cause different surveillance devices difficulties in sharing and communication information with one another. In addition, controls of surveillance systems are usually rigid and not user friendly.

### BRIEF DESCRIPTION OF THE DRAWINGS

FIG. 1 is a schematic diagram of a surveillance control system and environment thereof.

FIG. 2 is a block diagram of one embodiment of the surveillance control system.

FIG. 3 is a flowchart illustrating one embodiment of a method for surveillance control.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the module may be integrated in firmware, such as an EPROM. It will be appreciated that module may comprise connected logic units, such as gates and flip-flops, and may comprise programmable units, such as programmable gate arrays or processors. The units described herein may be implemented as software and/or hardware unit and may be stored in any type of computer-readable medium or other computer storage device.

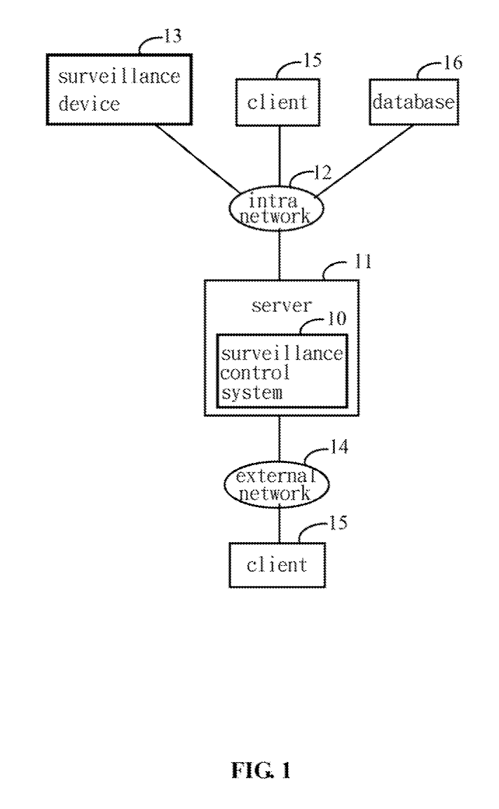

FIG. 1 is a schematic diagram of an environment of a server 11 comprising a surveillance control system 10. The server 11 connects with at least one surveillance device 13 via a intra-network 12. The server 11 is also in connection with an external network 14. The at least one surveillance device 13 can be a webcam, a digital video recorder (DVR), or a digital video server (DVS), for example. Each one of the at least one surveillance device 13 is placed at a monitor point to gather onsite video data. The monitor point is a monitor site where the at least one surveillance device 13 is at. The surveillance control system 10 retrieves the video data from the corresponding surveillance device 13 and, in response to a playback request from a client terminal 15, re-encodes and transmits the video data to the client terminal 15. The client terminal 15 can be in connection with either the intra-network 12 or the external network 14. The intra-network can be an enterprise local area network (LAN), and the external network can be the Internet, for example. In the embodiment, the server 11 is in connection with a database 16 via the intra-network. The database 16 stores device information of the security monitoring device 13, such as an IP address and port number of the security monitoring device 13.

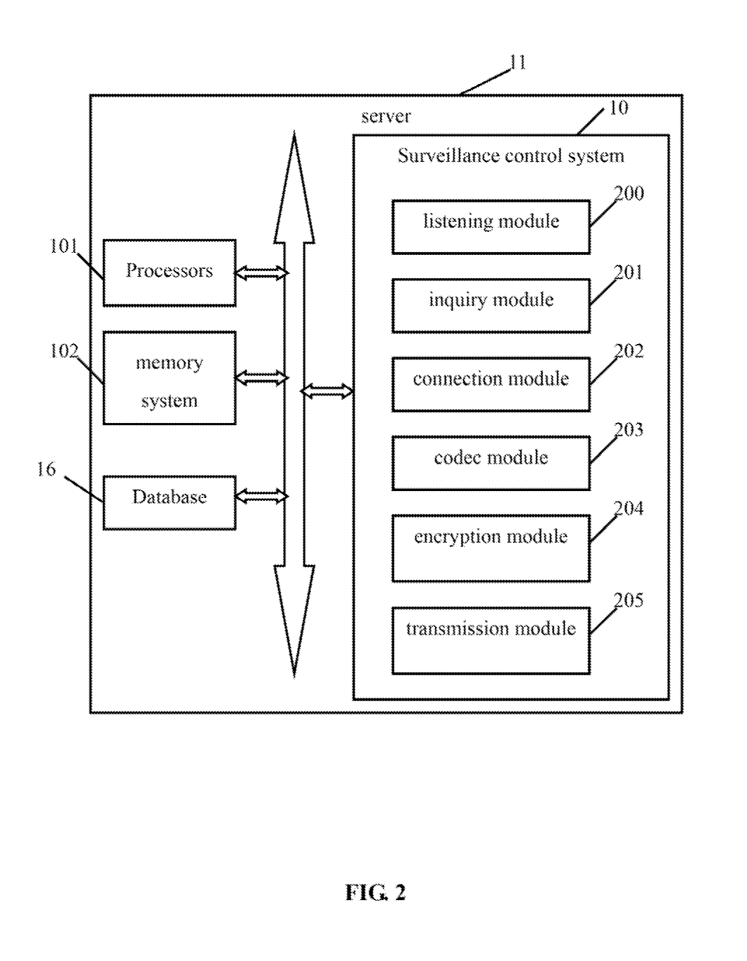

FIG. 2 is a block diagram of one embodiment of the security monitoring control system 10. The system 10 includes various programs including a listening module 200, a inquiry module 210, a connection module 220, a codec module 230, a encryption module 240, and a transmission module 250. One or more computerized codes of the modules 200-250 are stored in a memory system 102 and executed by one or more processors 101 of the server 10.

In the embodiment, the listening module 200 receives the playback request from the client terminal 15, using real time streaming protocol (RTSP). For example, the listening module 200 can receive the playback request of “conference room 001, 2^{nd} floor, building A” from the client terminal 15 which connects to the external network 14. The playback request described can be a playback request of a live video feed or a playback of certain portion of recorded video.

In the embodiment, the inquiry module 210 locates the surveillance device 13 corresponding to the monitor point and acquires the device information of the surveillance device 13, such as IP address and port number. The surveillance device 13 can be a webcam, a digital video recorder (DVR), or digital video server (DVS), for example.

In the embodiment, the connection module 220 sets up a connection with the surveillance device 13, using the acquired device information. The connection module 220 retrieves the corresponding video data from the surveillance device 13, according to the playback request. For example, the video data can be a live video feed, if the surveillance device 13 is the webcam. In addition, the video data can be the live video feed or playback of a specific portion of recorded video, if the surveillance device 13 is a DVR or DVS.

The codec module 230 decodes the retrieved video data and re-encodes the decoded video data with a predetermined codec. The decoding algorithm for each surveillance device 13 is stored in the database 16. In the embodiment, the codec module 230 acquires the decoding algorithm from the database 16, decodes the retrieved video data, and encodes the decoded video data with the predetermined codec, H.264 for example. If the client terminal is a mobile phone, the predetermined codec can be 3GP for compatibility, for example.

The encryption module 240 encrypts the re-encoded video data. In the embodiment, the encryption algorithm is data encryption standard (DES) algorithm. For example, if the codec module re-encodes the video data with cosine transform algorithm, the encryption module 240 encrypts accordingly a direct and alternating component of the transformed video data with the DES algorithm. The encryption module 240 can adopt other encryption algorithms, advanced encryption standard (AES) or chaos algorithm, for example.

The transmission module 250 transmits the encrypted video data to the client terminal 15. In the embodiment, the transmission module packages the re-encoded video data into real time protocol (RTP) packets and sends the packets to the client terminal 15. The client terminal 15 uses corresponding decryption and decoding algorithm to decrypt and decode the video data.

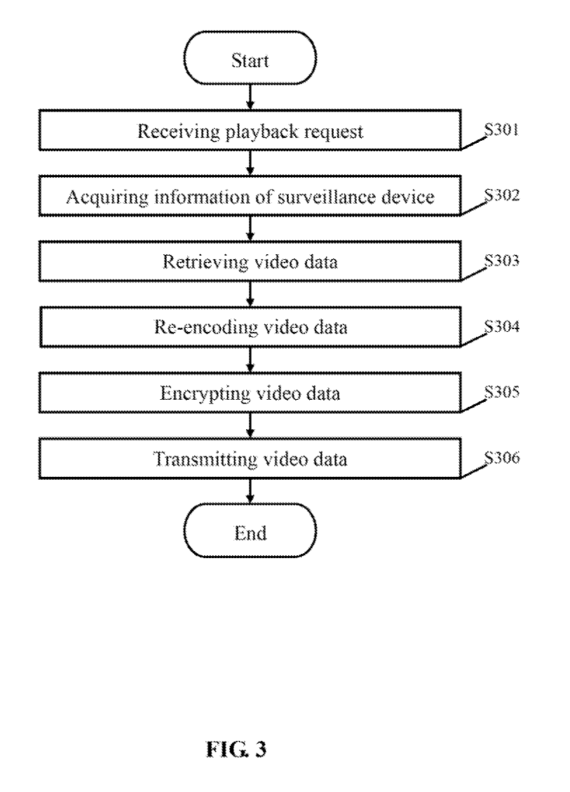

FIG. 3 is a flowchart illustrating one embodiment of a method for surveillance control. Additional blocks may be added to the method, others removed, and the ordering of the blocks may be changed.

In block S301, the listening module 200 receives the playback request from the client terminal 15. For example, the listening module 200 can receive the playback request of “conference room 001, 2^{nd} floor, building A” from the client terminal 15 which connects to the external network 14. The playback request describe herein can be a playback request for live video feed or a playback of a specific portion of recorded video. In the embodiment, the listening module 200 receives the playback request from the client terminal 15, using the RTSP.

In block S302, the inquiry module 210 locates the surveillance device 13 corresponding to the monitor point and acquires the device information of the surveillance device 13, such as IP address and port number. In the embodiment, the surveillance device 13 can be a webcam, DVR, or DVS, for example.

In block S303, the connection module 220 sets up the connection with the surveillance device 13, using the acquired device information. In the embodiment, the connection module 220 retrieves the corresponding video data from the surveillance device 13, according to the playback request. For example, the video data can be live video feed, if the surveillance device 13 is the webcam. In addition, the video data can be the live video feed or playback of a specific portion of recorded video, if the surveillance device 13 is a DVR, or DVS.

In block S304, the codec module 230 decodes the retrieved video data and re-encodes the decoded video data with the predetermined codec. The decode algorithm for each surveillance device 13 is stored in the database 16. In the embodiment, the codec module 230 acquires the decode algorithm from the database 16, decodes the retrieved video data, and encodes the decoded video data with the predetermined codec, H.264 for example. If the client terminal is the mobile phone, the predetermined codec can be 3GP for compatibility, for example.

In block S305, the encryption module 240 encrypts the re-encoded video data. In the embodiment, the encryption is the DES algorithm. For example, if the codec module re-encodes the video data with cosine transform algorithm, the encryption module 240 encrypts accordingly the direct and alternating component of the transformed video data with the DES algorithm. The encryption module 240 can adopt other encryption algorithms, the AES or chaos algorithm, for example.

In block S306, the transmission module 250 transmits the encrypted video data to the client terminal 15. In the embodiment, the transmission module packages the re-encoded video data into the RTP packets and sends the packets to the client terminal 15. The client terminal 15 uses corresponding decryption and decoding algorithm to decrypt and decode the video data.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a memory system;
one or more processors; and
one or more programs stored in the memory system configured to be executed by the one or more processors, the one or more programs comprising:
a listening module to receive a playback request of a video feed of a monitor point;
an inquiry module to locate a surveillance device corresponding to the monitor point and acquire device information of the surveillance device;
a connection module to set up a connection with the surveillance device using the acquired device information and retrieve video data from the surveillance device;
a codec module to decode the retrieved video data and re-encode the retrieved video data with a predetermined codec; and
a transmission module to transmit the re-encoded video data.

2. The device as claimed in claim 1, wherein the electronic device further comprises a encryption module to encrypt the re-encoded video data.

3. The device as claimed in claim 1, wherein the listening module receives the playback request using real time streaming protocol (RTSP).

4. The device as claimed in claim 1, wherein the predetermined codec is H.264.

5. The device as claimed in claim 1, wherein the transmission module packages the re-encoded video data into a plurality of RTP packets prior to transmission.

6. A computerized method of an electronic device, comprising:
receiving a playback request of a video feed of a monitor point;
locating a surveillance device corresponding to the monitor point;
acquiring device information of the surveillance device;
setting up a connection with the surveillance device using the acquired device information;
retrieving video data from the surveillance device;
decoding the retrieved video data;
re-encoding the retrieved video data with a predetermined codec; and
transmitting the re-encoded video data.

7. The computerized method as claimed in claim 6, further comprising encrypting the re-encoded video data.

8. The computerized method as claimed in claim 6, wherein the playback request is received using real time streaming protocol.

9. The computerized method as claimed in claim 6, wherein the predetermined codec is H.264.

10. The computerized method as claimed in claim 6, wherein the method further comprises packaging the re-encoded video data into a plurality of RTP packets prior to transmission.

11. A computer readable storage medium having stored therein instructions, that when executed by one or more processors of an electronic device, cause the device to:
receive a playback request of a video feed of a monitor point;
locate a surveillance device corresponding to the monitor point;
acquire device information of the surveillance device;
set up a connection with the surveillance device using the acquired device information;
retrieve video data from the surveillance device;
decode the retrieved video data;
re-encode the retrieved video data with a predetermined codec; and
transmit the re-encoded video data.

12. The computer readable storage medium as claimed in the claim 11, wherein the instructions further cause the device to encrypt the re-encoded video data.

13. The computer readable storage medium as claimed in the claim 11, wherein the playback request is received using real time streaming protocol.

14. The computer readable storage medium as claimed in the claim 11, wherein the predetermined codec is H.264.

15. The computer readable storage medium as claimed in the claim 11, wherein the instructions further cause the device to package the re-encoded video data into a plurality of RTP packets prior to transmission.
